(19) United States
(12) Patent Application Publication
(10) Pub. No.: US 2022/0300795 A1
(43) Pub. Date: Sep. 22, 2022

(54) TWO-STAGE DECOMPRESSION PIPELINE FOR NON-UNIFORM QUANTIZED NEURAL NETWORK INFERENCE ON RECONFIGURABLE HARDWARE

(71) Applicant: Intel Corporation, Santa Clara, CA (US)

(72) Inventors: Yash Akhauri, Noida (IN); Nilesh Jain, Portland, OR (US); Pasquale Cocchini, Portland, OR (US); Eriko Nurvitadhi, Hillsboro, OR (US)

(21) Appl. No.: 17/836,523

(22) Filed: Jun. 9, 2022

(51) Int. Cl. G06N 3/063; G06F 17/16

(52) U.S. Cl. CPC G06N 3/063; G06F 17/16

(57) ABSTRACT

Systems, apparatuses and methods may provide for technology that includes a performance-enhanced decompression pipeline having first decoder hardware to convert variable length weights to fixed length keys, wherein the variable length weights are non-uniform quantization values, and second decoder hardware to convert the fixed length keys to bit value. In one example, the first length keys are compressed representations of the variable length weights and the bit values are bit accurate representations of the fixed length keys.

### TECHNICAL FIELD

Embodiments generally relate to machine learning. More particularly, embodiments relate to a two-stage decompression pipeline for non-uniform quantized neural network inference on reconfigurable hardware.

### BACKGROUND OF THE DISCLOSURE

Neural networks may be useful in a variety of applications such as, for example, artificial intelligence (AI) based image recognition and/or analysis. For example, a deep learning model might be trained to determine weights that will be used to draw image recognition inferences. As neural networks increase in size and complexity, inference on reconfigurable hardware (e.g., programmable logic arrays/PLAs, field programmable gate arrays/FPGAs, complex programmable logic devices/CPLDs, general purpose microprocessors, etc.) is proving to be a challenge due to limited memory bandwidth. One of the major architectural constraints for neural network inference on FPGAs is memory bottleneck problems. Additionally, energy consumption due to external memory transfers may also be a major concern.

### BRIEF DESCRIPTION OF THE DRAWINGS

The various advantages of the embodiments will become apparent to one skilled in the art by reading the following specification and appended claims, and by referencing the following drawings, in which:

FIG. 1 is an illustration of an example of a conversion of variable length weights to fixed length keys according to an embodiment;

FIG. 2 is a block diagram of an example of a decompression pipeline according to an embodiment;

FIG. 3 is a block diagram of an example of a variable length decompression unit according to an embodiment;

FIG. 4 is a block diagram of an example of a plurality of variable length decompression units coupled to a block random access memory (BRAM) according to an embodiment;

FIG. 5 is a block diagram of an example of a plurality of variable length decoders coupled to a plurality of BRAMs according to an embodiment;

FIG. 6 is a block diagram of an example of a plurality of fixed length decoders coupled to a BRAM according to an embodiment;

FIG. 7 is a block diagram of an example of fixed length decoder hardware coupled to a plurality of BRAMs and a plurality of processing elements according to an embodiment;

FIG. 8 is an illustration of an example of a look-up table (LUT) cost estimate function according to an embodiment;

FIG. 9 is a flowchart of an example of a method of operating a decompression pipeline according to an embodiment;

FIG. 10 is a block diagram of an example of a performance-enhanced computing system according to an embodiment;

FIG. 11 is an illustration of an example of a semiconductor package apparatus according to an embodiment;

FIG. 12 is a block diagram of an example of a processor according to an embodiment; and

FIG. 13 is a block diagram of an example of a multi-processor based computing system according to an embodiment.

### DETAILED DESCRIPTION

As already noted, neural networks may train a deep learning model to determine weights (e.g., floating point values) that will be used to draw inferences in applications such as, artificial intelligence (AI) based image recognition/analysis, natural language processing, and so forth. Non-uniform quantization of the weights typically increases accuracy but may present memory bandwidth and/or power consumption challenges due to the variable length of the quantized weights. To achieve energy efficient inference of non-uniform quantized neural networks on reconfigurable hardware (e.g., FPGAs, PLDs, CPLDs) with lower resource counts, the technology described herein involves a two-stage decompression pipeline for weights that reduces both memory transfers from dynamic random access memory (DRAM) as well as through the on-chip memory of the reconfigurable hardware.

Non uniform quantization can be thought of as having a dictionary, where the “keys” to the dictionary are of low bit-width and the “values” in the dictionary are of higher bit-width. Dictionary based solutions may be advantageous for neural network compression, but implementation of such solutions for inference may be limited due to dictionary lookup overhead. Non-uniform quantization may subsume all uniform/powers of two or similar quantization methods and is only limited by the number of dictionary keys allowed in a weight matrix. As focus shifts towards heavily quantized neural networks, focusing on non-uniform quantization will be of very high utility to obtain better accuracy with strict model size constraints. Embodiments involve enhanced technology that enables the discovery and acceleration of inferencing on dictionary based weight shared/non-uniform quantized neural networks on reconfigurable hardware.

One way in which the weights are “shared” (e.g., non-uniformly quantized) is when a matrix has a size of, for example, 64×64, but is quantized to 8 bits. In such a case, there can be only 256 unique values in the elements of the 64×64 matrix. These 256 values will be “shared” as they are repeated.

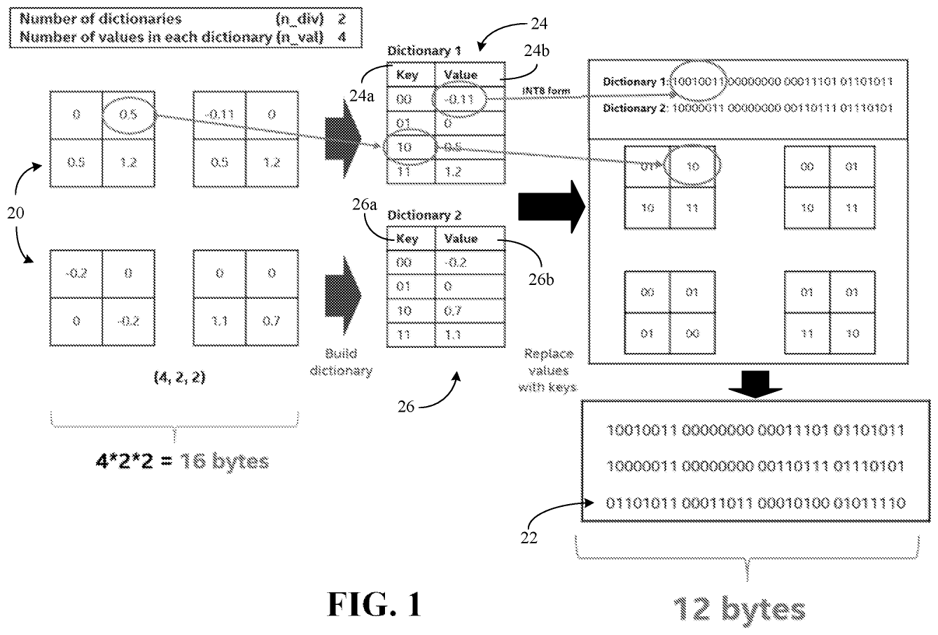

FIG. 1 shows a conversion from a plurality of weight matrices 20 (e.g., weight tensor with variable length weights) to fixed length keys 22 in a dictionary based weight sharing/non-uniform weight quantization solution. In the illustrated example, “n_div” and “n_val”, refer to the number of dictionaries and the number of unique values in each dictionary, respectively. The weight tensor is divided equally into n_div sub-tensors and each such sub-tensor is enforced to have only n_val unique values at train time. In one example, the values are INT8 (8-bit integers), although other data formats may be used.

The illustrated conversion uses fixed length coding (FLC) for the weight values. Another stage of compression may be added by using “Huffman Codes”, which are an optimal prefix code that is commonly used for lossless data compression. The common problem with having a Huffman Code is the variable code lengths of the weight matrices 20. The variable code lengths may make the decompression process strictly sequential, and therefore difficult to parallelize. Weights can be compressed offline, however, so it is trivial to lay the architecture out in such a way that parallel bitstreams can be decompressed to provide to processing elements in a matrix vector multiplication unit. Decompression will be completely synchronized as each Huffman decompression engine (variable length coding/VLC to FLC decompressor) decompresses the same number of values to provide to the matrix vector multiplication unit. More particularly, a first dictionary 24 (24a, 24b) stores keys 24a and values 24b for a first sub-tensor of the weight matrices 20 and a second dictionary 26 (26a, 26b) stores keys 26a and values 26b for a second sub-tensor of the weight matrices 20.

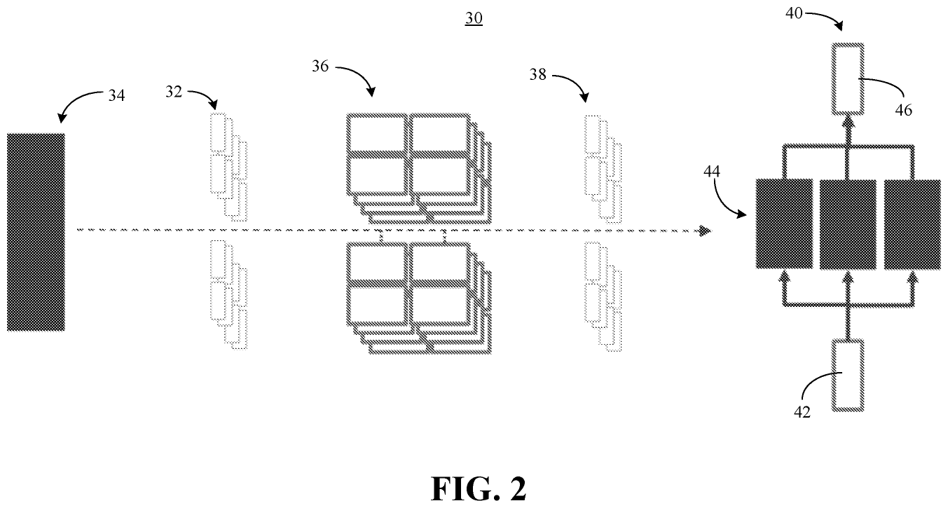

Turning now to FIG. 2, a decompression pipeline 30 is shown in which first decoder hardware 32 (e.g., VLC to FLC look-up table/LUT decoder, processing one value per clock) converts variable length weights to fixed length keys, wherein the variable length weights are non-uniform quantization values. Thus, the fixed length keys may be similar to the fixed length keys 22 (FIG. 1), which are compressed representations of the variable length weights. In an embodiment, the first decoder hardware 32 retrieves the variable length weights from a dynamic random access memory (DRAM) 34 and stores the fixed length keys to one or more block random access memory (BRAM) banks 36, wherein a BRAM bank is a plurality of BRAMs.

Additionally, second decoder hardware 38 (e.g., FLC to value LUT decoder) converts the fixed length keys to bit values (e.g., bit accurate representations of the fixed length keys) based on one or more dictionaries such as, for example, the dictionaries 24, 26 (FIG. 1), already discussed. In an embodiment, the second decoder hardware 38 retrieves the fixed length keys from the BRAM bank(s) 36 and sends the bit values to a matrix vector multiplication unit (MVMU) 40 for inference processing. For example, the MVMU 40 might use the bit values to process an image stream 42 (e.g., received via a network controller) through a plurality of single instruction multiple data (SIMD) lanes 44 (e.g., Q lanes) to obtain an output stream 46 (e.g., inference result).

Thus, the weights are compressed and stored in the DRAM 34, from where the weights are fetched to the first decoder hardware 34, which converts the Huffman compressed weights to fixed length compressed representations of the true values. These fixed length compressed representations (e.g., dictionary keys) of the true values are then stored in the BRAM bank(s) 36. The BRAM bank(s) 36 then feed the second decoder hardware 38 to obtain the true bit accurate representation of the compressed weights, which can be fed to the MVMU 40 for multiplication.

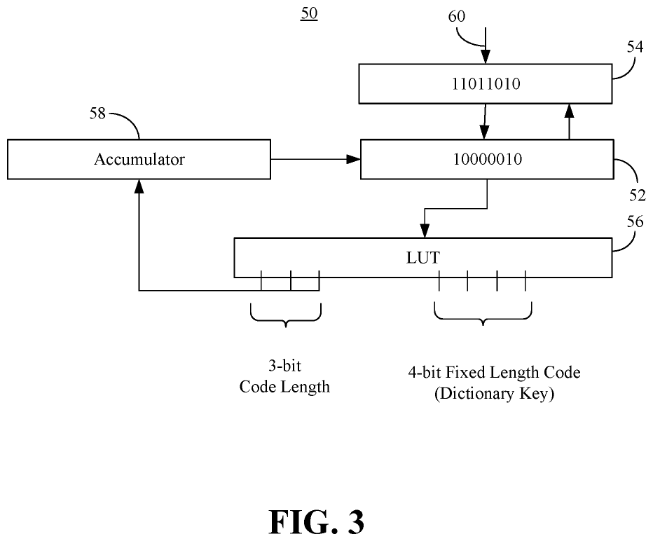

FIG. 3 shows a single variable length decompression unit 50 that includes a primary buffer 52, a secondary buffer 54, an LUT unit 56 and an accumulator 58. There is an input data-stream 60 that feeds the secondary buffer 54. The primary buffer 52 feeds the LUT unit 56 for converting VLC to FLC. Further, the LUT unit 56 also contains the variable code length of the code input from the primary buffer 52. This code length is fed to the accumulator 58, which decides how the primary buffer 52 loads new data from the secondary buffer 54.

For instance, if there are 16 unique INT8 values allowed in the original matrix, a 4 bit “fixed length code” can be used to represent the INT8 values. Further, depending on the weight distribution, these 4-bit fixed length code representations can be compressed further by using Huffman codes. Assume that for the INT8 value “233”, the INT4 (4-bit integer) fixed length code is 1101 and the Huffman code is 010. In such a case, the variable length decompression unit 50 would take data from the primary buffer 52, identify the code ‘010’ at the least significant place of the primary buffer 52. The variable length decompression unit 50 would then output the 4-bit fixed length code (1101), as well as the number of bits of the VLC (len(010)=3 (011b)). The 011 would go to the accumulator 58, which would decide whether to shift in more data from the secondary buffer 54, or flush the entire secondary buffer 54 into the primary buffer 52. The latter would occur when len(VLC)==sizeof(Primary Buffer).

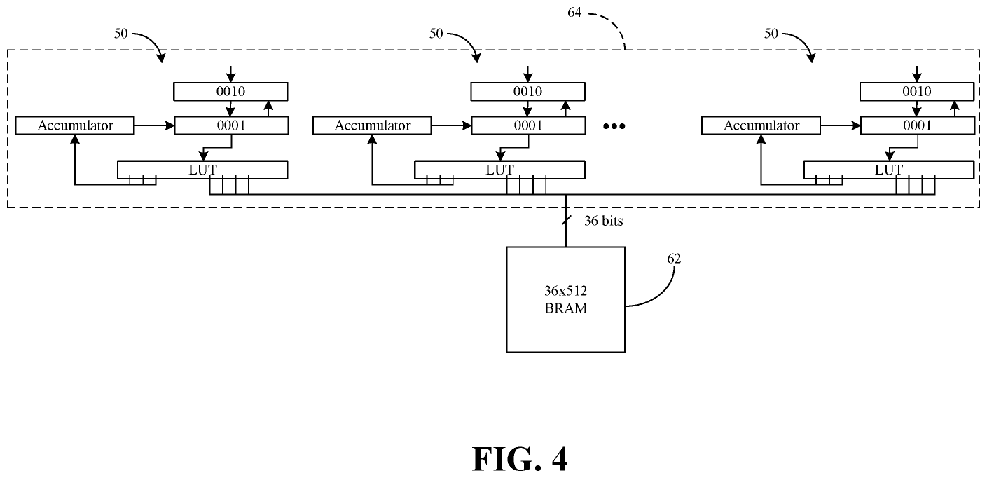

FIG. 4 shows a plurality of variable length decompression units 50 coupled to a BRAM 62. The illustrated layout only adds an overhead of one cycle since the variable length decompression units 50 are streaming decompressors. The LUT cost for implementing the decompression units 50 is also minimal when compared to the number of logic cells contained in a typical FPGA. The plurality of variable length decompression units 50 that feed a single BRAM 62 may be referred to as a single VLC-FLC decoder 64.

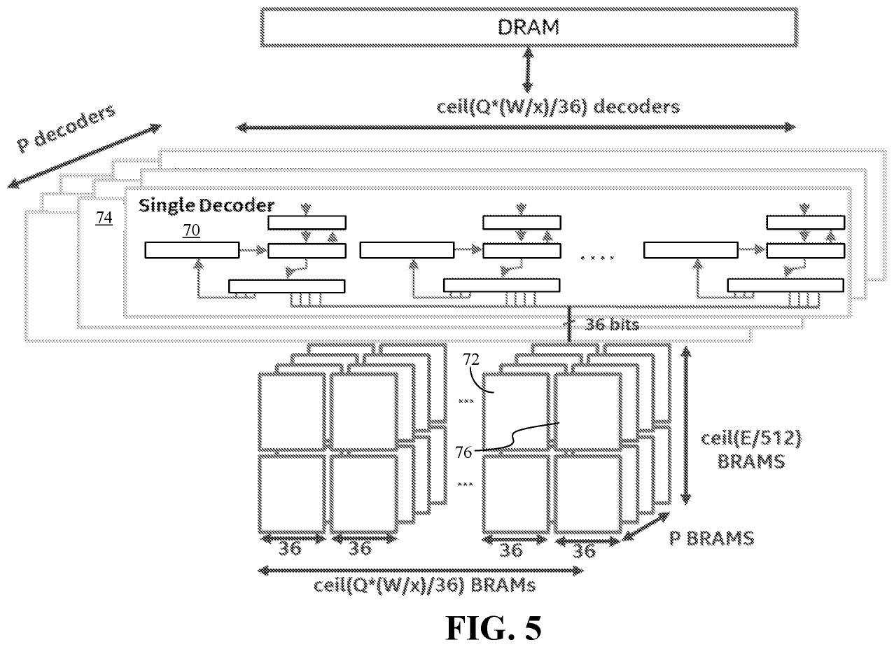

FIG. 5 shows a first VLC-FLC decoder 70 (e.g., first plurality of variable length decompression units) coupled to a first BRAM 72, a second VLC-FLC decoder 74 (e.g., second plurality of variable length decompression units) coupled to a second BRAM 76, and so forth. Thus, the illustrated architecture extends the single VLC-FLC decoder 64 (FIG. 4) in the presence of many BRAMs 72, 76.

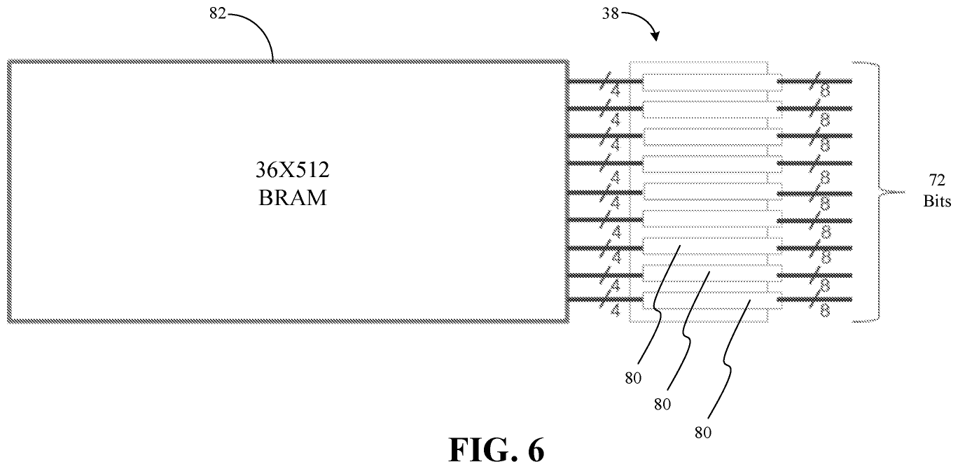

FIG. 6 shows an example of the second decoder hardware 38 in which a plurality of fixed length decoders 80 are coupled to a single BRAM 82. Decompressing fixed length codes to their true values is relatively straightforward with LUT units. For example, if the conversion is from 4-bit fixed length codes to 8-bit true representations, nine 4:8 LUTs configured with the dictionary key—value pairs may be used.

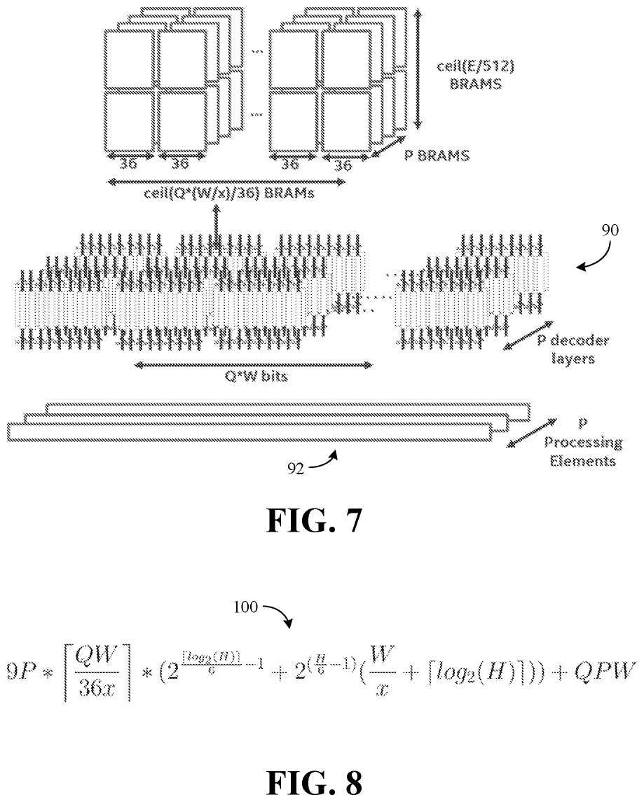

FIG. 7 shows the layout of a plurality of BRAM FLC-Value LUT decoders 90 that feed “P” processing elements 92 in a parallel fashion. The processing elements 92 may be incorporated into an MVMU such as, for example, the MVMU 40 (FIG. 2), already discussed.

Turning now to FIG. 8, a cost estimate function 100 is shown for an LUT implementation. In the illustrated example, Q: Number of values multiplied and accumulated by a single processing element; P: Number of processing elements; W. Uncompressed Bit-Width of weights; x: Fixed length compression ratio; and H: Maximum Huffman code length (decides the LUT cost for the VLC-FLC decoder). The technology described herein provides significant LUT cost savings and reduced BRAM usage.

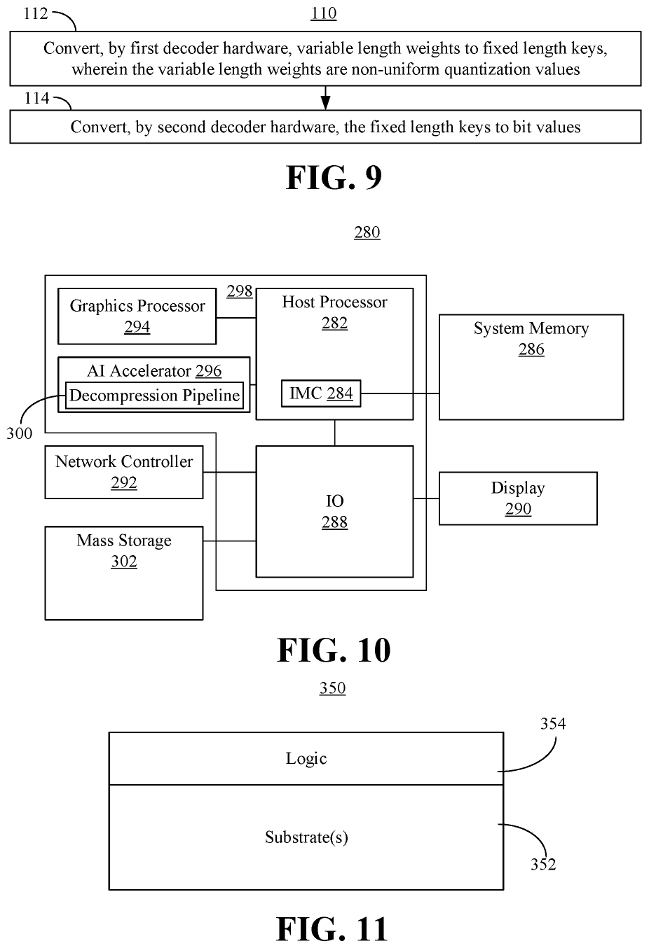

FIG. 9 shows a method 110 of operating a decompression pipeline. The method 110 may generally implemented in a decompression pipeline such as, for example, the decompression pipeline 30 (FIG. 2), already discussed. More particularly, the method 110 be implemented in one or more modules as a set of logic instructions stored in a machine-or computer-readable storage medium such as random access memory (RAM), read only memory (ROM), programmable ROM (PROM), firmware, flash memory, etc., in hardware, or any combination thereof. For example, hardware implementations may include configurable logic, fixed-functionality logic, or any combination thereof. Examples of configurable logic include suitably configured programmable logic arrays (PLAs), field programmable gate arrays (FPGAs), complex programmable logic devices (CPLDs), and general purpose microprocessors. Examples of fixed-functionality logic include suitably configured application specific integrated circuits (ASICs), combinational logic circuits, and sequential logic circuits. The configurable or fixed-functionality logic can be implemented with complementary metal oxide semiconductor (CMOS) logic circuits, transistor-transistor logic (TTL) logic circuits, or other circuits.

Computer program code to carry out operations shown in the method 110 can be written in any combination of one or more programming languages, including an object oriented programming language such as JAVA, SMALLTALK, C++ or the like and conventional procedural programming languages, such as the “C” programming language or similar programming languages. Additionally, logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

Illustrated processing block 112 provides for converting, by first decoder hardware, variable length weights to fixed length keys, wherein the variable length weights are non-uniform quantization values. In an embodiment, the fixed length keys are compressed representations of the variable length weights. Additionally, block 112 may include retrieving, by the first decoder hardware, the variable length weights from DRAM and storing, by the first decoder hardware, the fixed length keys to one or more BRAM banks. In one example, the first decoder hardware includes a first plurality of variable length decompression units coupled to a first BRAM and a second plurality of variable length decompression units coupled to a second BRAM.

Block 114 converts, by second decoder hardware, the fixed length keys to bit values. In an embodiment, the bit values are bit accurate representations of the fixed length keys. Additionally, the fixed length keys may be converted to the bit values based on one or more dictionaries. In one example, block 114 includes retrieving, by the second decoder hardware, the fixed length keys from one or more BRAM banks and sending, by the second decoder hardware, the bit values to a matrix vector multiplication unit. Moreover, the fixed length keys may be converted to the bit values by a plurality of fixed length decoders in the second decoder hardware. The method 110 therefore enhances performance at least to the extent that the two-stage decompression pipeline accelerates inference of non-uniform quantized neural networks, reduces energy requirements and/or reduces memory element requirements on reconfigurable hardware.

Turning now to FIG. 10, a performance-enhanced computing system 280 is shown. The system 280 may generally be part of an electronic device/platform having computing functionality (e.g., personal digital assistant/PDA, notebook computer, tablet computer, convertible tablet, server), communications functionality (e.g., smart phone), imaging functionality (e.g., camera, camcorder), media playing functionality (e.g., smart television/TV), wearable functionality (e.g., watch, eyewear, headwear, footwear, jewelry), vehicular functionality (e.g., car, truck, motorcycle), robotic functionality (e.g., autonomous robot), Internet of Things (IoT) functionality, etc., or any combination thereof.

In the illustrated example, the system 280 includes a host processor 282 (e.g., central processing unit/CPU) having an integrated memory controller (IMC) 284 that is coupled to a system memory 286 (e.g., dual inline memory module/DIMM). In an embodiment, an IO (input/output) module 288 is coupled to the host processor 282. The illustrated IO module 288 communicates with, for example, mass storage 302 (e.g., hard disk drive/HDD, solid state drive/SDD, optical disc), a display 290 (e.g., touch screen, liquid crystal display/LCD, light emitting diode/LED display), and a network controller 292 (e.g., wired and/or wireless). The host processor 282 may be combined with the IO module 288, a graphics processor 294, and an AI accelerator 296 into a system on chip (SoC) 298. In one example, the network controller 292 obtains image data corresponding to a scene.

In an embodiment, the AI accelerator 296 includes a decompression pipeline 300 to perform one or more aspects of the method 110 (FIG. 9), already discussed. The decompression pipeline 300 may also be similar to the decompression pipeline 30 (FIG. 2), already discussed. Thus, the decompression pipeline 300 may include first decoder hardware to convert variable length weights to fixed length keys, wherein the variable length weights are non-uniform quantization values. The decompression pipeline 300 may also include second decoder hardware to convert the fixed length keys to bit values. The computing system 280 is therefore considered performance-enhanced at least to the extent that the two-stage decompression pipeline 300 accelerates inference of non-uniform quantized neural networks, reduces energy requirements and/or reduces memory element requirements on reconfigurable hardware.

FIG. 11 shows a semiconductor apparatus 350 (e.g., chip, die, package). The illustrated apparatus 350 includes one or more substrates 352 (e.g., silicon, sapphire, gallium arsenide) and logic 354 (e.g., transistor array and other integrated circuit/IC components) coupled to the substrate(s) 352. In an embodiment, the logic 354 implements one or more aspects of the method 110 (FIG. 9), already discussed. Thus, the logic 354 may convert, by first decoder hardware, variable length weights to fixed length keys, wherein the variable length weights are non-uniform quantization values. The logic 354 may also convert, by second decoder hardware, the fixed length keys to bit values.

The logic 354 may be implemented at least partly in configurable or fixed-functionality hardware. In one example, the logic 354 includes transistor channel regions that are positioned (e.g., embedded) within the substrate(s) 352. Thus, the interface between the logic 354 and the substrate(s) 352 may not be an abrupt junction. The logic 354 may also be considered to include an epitaxial layer that is grown on an initial wafer of the substrate(s) 352.

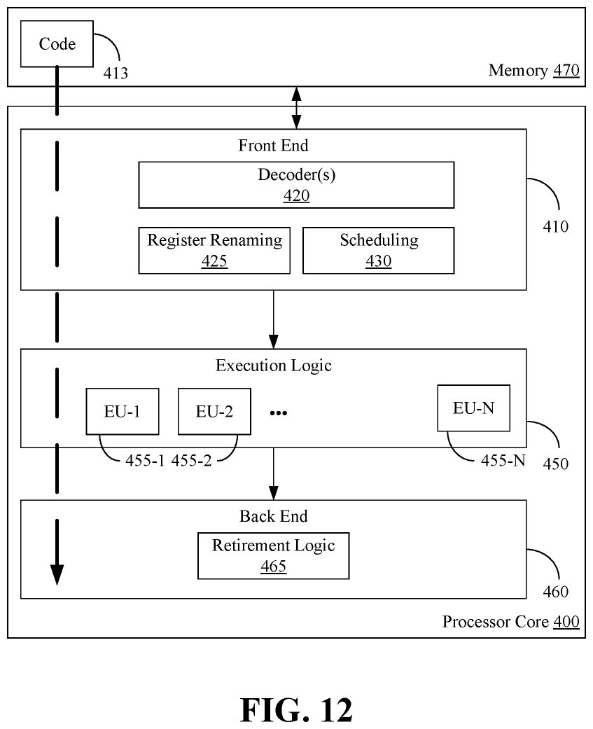

FIG. 12 illustrates a processor core 400 according to one embodiment. The processor core 400 may be the core for any type of processor, such as a micro-processor, an embedded processor, a digital signal processor (DSP), a network processor, or other device to execute code. Although only one processor core 400 is illustrated in FIG. 12, a processing element may alternatively include more than one of the processor core 400 illustrated in FIG. 12. The processor core 400 may be a single-threaded core or, for at least one embodiment, the processor core 400 may be multithreaded in that it may include more than one hardware thread context (or “logical processor”) per core.

FIG. 12 also illustrates a memory 470 coupled to the processor core 400. The memory 470 may be any of a wide variety of memories (including various layers of memory hierarchy) as are known or otherwise available to those of skill in the art. The memory 470 may include one or more code 413 instruction(s) to be executed by the processor core 400, wherein the code 413 may implement the method 110 (FIG. 9), already discussed, already discussed. The processor core 400 follows a program sequence of instructions indicated by the code 413. Each instruction may enter a front end portion 410 and be processed by one or more decoders 420. The decoder 420 may generate as its output a micro operation such as a fixed width micro operation in a predefined format, or may generate other instructions, microinstructions, or control signals which reflect the original code instruction. The illustrated front end portion 410 also includes register renaming logic 425 and scheduling logic 430, which generally allocate resources and queue the operation corresponding to the convert instruction for execution.

The processor core 400 is shown including execution logic 450 having a set of execution units 455-1 through 455-N. Some embodiments may include a number of execution units dedicated to specific functions or sets of functions. Other embodiments may include only one execution unit or one execution unit that can perform a particular function. The illustrated execution logic 450 performs the operations specified by code instructions.

After completion of execution of the operations specified by the code instructions, back end logic 460 retires the instructions of the code 413. In one embodiment, the processor core 400 allows out of order execution but requires in order retirement of instructions. Retirement logic 465 may take a variety of forms as known to those of skill in the art (e.g., re-order buffers or the like). In this manner, the processor core 400 is transformed during execution of the code 413, at least in terms of the output generated by the decoder, the hardware registers and tables utilized by the register renaming logic 425, and any registers (not shown) modified by the execution logic 450.

Although not illustrated in FIG. 12, a processing element may include other elements on chip with the processor core 400. For example, a processing element may include memory control logic along with the processor core 400. The processing element may include I/O control logic and/or may include I/O control logic integrated with memory control logic. The processing element may also include one or more caches.

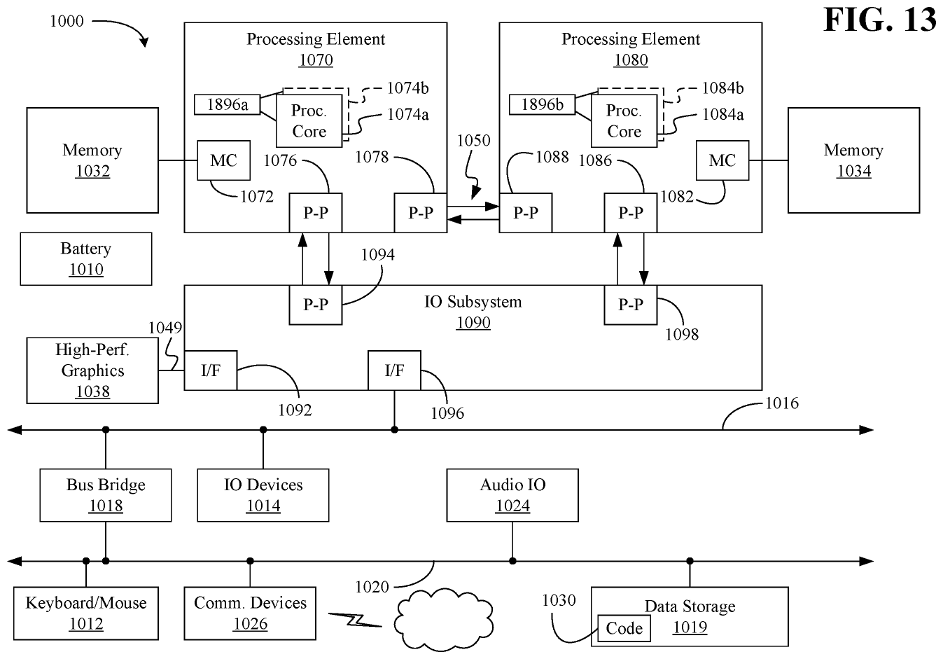

Referring now to FIG. 13, shown is a block diagram of a computing system 1000 embodiment in accordance with an embodiment. Shown in FIG. 13 is a multiprocessor system 1000 that includes a first processing element 1070 and a second processing element 1080. While two processing elements 1070 and 1080 are shown, it is to be understood that an embodiment of the system 1000 may also include only one such processing element.

The system 1000 is illustrated as a point-to-point interconnect system, wherein the first processing element 1070 and the second processing element 1080 are coupled via a point-to-point interconnect 1050. It should be understood that any or all of the interconnects illustrated in FIG. 13 may be implemented as a multi-drop bus rather than point-to-point interconnect.

As shown in FIG. 13, each of processing elements 1070 and 1080 may be multicore processors, including first and second processor cores (i.e., processor cores 1074a and 1074b and processor cores 1084a and 1084b). Such cores 1074a, 1074b, 1084a, 1084b may be configured to execute instruction code in a manner similar to that discussed above in connection with FIG. 12.

Each processing element 1070, 1080 may include at least one shared cache 1896a, 1896b. The shared cache 1896a, 1896b may store data (e.g., instructions) that are utilized by one or more components of the processor, such as the cores 1074a, 1074b and 1084a, 1084b, respectively. For example, the shared cache 1896a, 1896b may locally cache data stored in a memory 1032, 1034 for faster access by components of the processor. In one or more embodiments, the shared cache 1896a, 1896b may include one or more mid-level caches, such as level 2 (L2), level 3 (L3), level 4 (L4), or other levels of cache, a last level cache (LLC), and/or combinations thereof.

While shown with only two processing elements 1070, 1080, it is to be understood that the scope of the embodiments are not so limited. In other embodiments, one or more additional processing elements may be present in a given processor. Alternatively, one or more of processing elements 1070, 1080 may be an element other than a processor, such as an accelerator or a field programmable gate array. For example, additional processing element(s) may include additional processors(s) that are the same as a first processor 1070, additional processor(s) that are heterogeneous or asymmetric to processor a first processor 1070, accelerators (such as, e.g., graphics accelerators or digital signal processing (DSP) units), field programmable gate arrays, or any other processing element. There can be a variety of differences between the processing elements 1070, 1080 in terms of a spectrum of metrics of merit including architectural, micro architectural, thermal, power consumption characteristics, and the like. These differences may effectively manifest themselves as asymmetry and heterogeneity amongst the processing elements 1070, 1080. For at least one embodiment, the various processing elements 1070, 1080 may reside in the same die package.

The first processing element 1070 may further include memory controller logic (MC) 1072 and point-to-point (P-P) interfaces 1076 and 1078. Similarly, the second processing element 1080 may include a MC 1082 and P-P interfaces 1086 and 1088. As shown in FIG. 13, MC's 1072 and 1082 couple the processors to respective memories, namely a memory 1032 and a memory 1034, which may be portions of main memory locally attached to the respective processors. While the MC 1072 and 1082 is illustrated as integrated into the processing elements 1070, 1080, for alternative embodiments the MC logic may be discrete logic outside the processing elements 1070, 1080 rather than integrated therein.

The first processing element 1070 and the second processing element 1080 may be coupled to an I/O subsystem 1090 via P-P interconnects 1076 1086, respectively. As shown in FIG. 13, the I/O subsystem 1090 includes P-P interfaces 1094 and 1098. Furthermore, I/O subsystem 1090 includes an interface 1092 to couple I/O subsystem 1090 with a high performance graphics engine 1038. In one embodiment, bus 1049 may be used to couple the graphics engine 1038 to the I/O subsystem 1090. Alternately, a point-to-point interconnect may couple these components.

In turn, I/O subsystem 1090 may be coupled to a first bus 1016 via an interface 1096. In one embodiment, the first bus 1016 may be a Peripheral Component Interconnect (PCI) bus, or a bus such as a PCI Express bus or another third generation I/O interconnect bus, although the scope of the embodiments are not so limited.

As shown in FIG. 13, various I/O devices 1014 (e.g., biometric scanners, speakers, cameras, sensors) may be coupled to the first bus 1016, along with a bus bridge 1018 which may couple the first bus 1016 to a second bus 1020. In one embodiment, the second bus 1020 may be a low pin count (LPC) bus. Various devices may be coupled to the second bus 1020 including, for example, a keyboard/mouse 1012, communication device(s) 1026, and a data storage unit 1019 such as a disk drive or other mass storage device which may include code 1030, in one embodiment. The illustrated code 1030 may implement the method 110 (FIG. 9), already discussed, already discussed. Further, an audio I/O 1024 may be coupled to second bus 1020 and a battery 1010 may supply power to the computing system 1000.

Note that other embodiments are contemplated. For example, instead of the point-to-point architecture of FIG. 13, a system may implement a multi-drop bus or another such communication topology. Also, the elements of FIG. 13 may alternatively be partitioned using more or fewer integrated chips than shown in FIG. 13.

### Additional Notes and Examples

Example 1 includes a computing system comprising a network controller and a decompression pipeline coupled to the network controller, the decompression pipeline including first decoder hardware to convert variable length weights to fixed length keys, wherein the variable length weights are non-uniform quantization values, and second decoder hardware to convert the fixed length keys to bit values.

Example 2 includes the computing system of Example 1, wherein the fixed length keys are compressed representations of the variable length weights.

Example 3 includes the computing system of Example 1, further including a dynamic random access memory (DRAM), and one or more block random access memory (BRAM) banks, wherein the first decoder hardware is further to retrieve the variable length weights from the DRAM and store the fixed length keys to the one or more BRAM banks.

Example 4 includes the computing system of Example 3, wherein the first decoder hardware includes a first plurality of variable length decompression units coupled to a first BRAM and a second plurality of decompression units coupled to a second BRAM.

Example 5 includes the computing system of Example 1, wherein the bit values are bit accurate representations of the fixed length keys.

Example 6 includes the computing system of Example 1, wherein the fixed length keys are converted to the bit values based on one or more dictionaries.

Example 7 includes the computing system of Example 1, further including one or more block random access memory (BRAM) banks, and a matrix vector multiplication unit wherein the second decoder hardware is to retrieve the fixed length keys from the one or more BRAM banks and send the bit values to the matrix vector multiplication unit.

Example 8 includes the computing system of any one of Examples 1 to 7, wherein the second decoder hardware includes a plurality of fixed length decoders.

Example 9 includes a performance-enhanced decompression pipeline comprising first decoder hardware to convert variable length weights to fixed length keys, wherein the variable length weights are non-uniform quantization values, and second decoder hardware to convert the fixed length keys to bit values.

Example 10 includes the decompression pipeline of Example 9, wherein the fixed length keys are compressed representations of the variable length weights.

Example 11 includes the decompression pipeline of Example 9, wherein the first decoder hardware is further to retrieve the variable length weights from dynamic random access memory (DRAM) and store the fixed length keys to one or more block random access memory (BRAM) banks.

Example 12 includes the decompression pipeline of Example 11, wherein the first decoder hardware includes a first plurality of variable length decompression units coupled to a first BRAM and a second plurality of variable length decompression units coupled to a second BRAM.

Example 13 includes the decompression pipeline of Example 9, wherein the bit values are bit accurate representations of the fixed length keys.

Example 14 includes the decompression pipeline of Example 9, wherein the fixed length keys are converted to the bit values based on one or more dictionaries.

Example 15 includes the decompression pipeline of Example 9, wherein the second decoder hardware is to retrieve the fixed length keys from one or more block random access memory (BRAM) banks and send the bit values to a matrix vector multiplication unit.

Example 16 includes the decompression pipeline of any one of Examples 9 to 15, wherein the second decoder hardware includes a plurality of fixed length decoders.

Example 17 includes a method of operating a decompression pipeline, the method comprising converting, by first decoder hardware, variable length weights to fixed length keys, wherein the variable length weights are non-uniform quantization values, and converting, by second decoder hardware, the fixed length keys to bit values.

Example 18 includes the method of Example 17, wherein the fixed length keys are compressed representations of the variable length weights.

Example 19 includes the method of Example 17, further including retrieving, by the first decoder hardware, the variable length weights from dynamic random access memory (DRAM), and storing, by the first decoder hardware, the fixed length keys to one or more block random access memory (BRAM) banks.

Example 20 includes the method of Example 19, wherein the first decoder hardware includes a first plurality of variable length decompression units coupled to a first BRAM and a second plurality of variable length decompression units coupled to a second BRAM.

Example 21 includes the method of Example 17, wherein the bit values are bit accurate representations of the fixed length keys.

Example 22 includes the method of Example 17, wherein the fixed length keys are converted to the bit values based on one or more dictionaries.

Example 23 includes the method of Example 17, further including retrieving, by the second decoder hardware, the fixed length keys from one or more block random access memory (BRAM) banks, and sending, by the second decoder hardware, the bit values to a matrix vector multiplication unit.

Example 24 includes the method of any one of Examples 17 to 23, wherein the fixed length keys are converted to the bit values by a plurality of fixed length decoders in the second decoder hardware.

Example 25 includes an apparatus comprising means for performing the method of any one of Examples 17 to 23.

Thus, technology described herein includes an accelerator design that is suited for general purpose non-uniform quantization inference, which is useful as a larger variety of neural network architectures are modeled for different tasks. To achieve energy efficient inference of non-uniform quantized neural networks on FPGAs with lower resource counts, a two-stage decompression pipeline is proposed for weights that reduce both the DRAM memory transfer required as well as on-chip memory. The first decoder hardware/stage can optimally utilize the BRAM Banks, and the second decoder hardware/stage is able to effectively utilize the LUTs to decode values extremely fast. The technology may also avoid the use of constrained weight values, such as “powers of two” quantization schemes. Such constraints make decompression of weights easier but are not general realizations of non-uniform quantizers. The technology may also eliminates the use of fixed length coding to compress the weights and then decompress it using weight lookup to an ALU (arithmetic logic unit).

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the computing system within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A; B; C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. A computing system comprising:
a network controller; and
a decompression pipeline coupled to the network controller, the decompression pipeline including:
first decoder hardware to convert variable length weights to fixed length keys, wherein the variable length weights are non-uniform quantization values, and
second decoder hardware to convert the fixed length keys to bit values.

2. The computing system of claim 1, wherein the fixed length keys are compressed representations of the variable length weights.

3. The computing system of claim 1, further including:
a dynamic random access memory (DRAM); and
one or more block random access memory (BRAM) banks, wherein the first decoder hardware is further to retrieve the variable length weights from the DRAM and store the fixed length keys to the one or more BRAM banks.

4. The computing system of claim 3, wherein the first decoder hardware includes a first plurality of variable length decompression units coupled to a first BRAM and a second plurality of decompression units coupled to a second BRAM.

5. The computing system of claim 1, wherein the bit values are bit accurate representations of the fixed length keys.

6. The computing system of claim 1, wherein the fixed length keys are converted to the bit values based on one or more dictionaries.

7. The computing system of claim 1, further including:
one or more block random access memory (BRAM) banks; and
a matrix vector multiplication unit wherein the second decoder hardware is to retrieve the fixed length keys from the one or more BRAM banks and send the bit values to the matrix vector multiplication unit.

8. The computing system of claim 1, wherein the second decoder hardware includes a plurality of fixed length decoders.

9. A decompression pipeline comprising:
first decoder hardware to convert variable length weights to fixed length keys, wherein the variable length weights are non-uniform quantization values; and
second decoder hardware to convert the fixed length keys to bit values.

10. The decompression pipeline of claim 9, wherein the fixed length keys are compressed representations of the variable length weights.

11. The decompression pipeline of claim 9, wherein the first decoder hardware is further to retrieve the variable length weights from dynamic random access memory (DRAM) and store the fixed length keys to one or more block random access memory (BRAM) banks.

12. The decompression pipeline of claim 11, wherein the first decoder hardware includes a first plurality of variable length decompression units coupled to a first BRAM and a second plurality of variable length decompression units coupled to a second BRAM.

13. The decompression pipeline of claim 9, wherein the bit values are bit accurate representations of the fixed length keys.

14. The decompression pipeline of claim 9, wherein the fixed length keys are converted to the bit values based on one or more dictionaries.

15. The decompression pipeline of claim 9, wherein the second decoder hardware is to retrieve the fixed length keys from one or more block random access memory (BRAM) banks and send the bit values to a matrix vector multiplication unit.

16. The decompression pipeline of claim 9, wherein the second decoder hardware includes a plurality of fixed length decoders.

17. A method comprising:
converting, by first decoder hardware, variable length weights to fixed length keys, wherein the variable length weights are non-uniform quantization values; and
converting, by second decoder hardware, the fixed length keys to bit values.

18. The method of claim 17, wherein the fixed length keys are compressed representations of the variable length weights.

19. The method of claim 17, further including:
retrieving, by the first decoder hardware, the variable length weights from dynamic random access memory (DRAM); and
storing, by the first decoder hardware, the fixed length keys to one or more block random access memory (BRAM) banks.

20. The method of claim 19, wherein the first decoder hardware includes a first plurality of variable length decompression units coupled to a first BRAM and a second plurality of variable length decompression units coupled to a second BRAM.

21. The method of claim 17, wherein the bit values are bit accurate representations of the fixed length keys.

22. The method of claim 17, wherein the fixed length keys are converted to the bit values based on one or more dictionaries.

23. The method of claim 17, further including:
retrieving, by the second decoder hardware, the fixed length keys from one or more block random access memory (BRAM) banks; and
sending, by the second decoder hardware, the bit values to a matrix vector multiplication unit.

24. The method of claim 17, wherein the fixed length keys are converted to the bit values by a plurality of fixed length decoders in the second decoder hardware.
